(19) United States
(12) Patent Application Publication
(10) Pub. No.: US 2012/0299548 A1
(43) Pub. Date: Nov. 29, 2012

(54) Battery System

(75) Inventors: Toshiki TAKAHASHI, Higashimurayama (JP); Shin Yamauchi, Mito (JP)

(73) Assignee: Hitachi, Ltd., Tokyo (JP)

(21) Appl. No.: 13/415,201

(22) Filed: Mar. 8, 2012

(30) Foreign Application Priority Data
May 23, 2011 (JP) 2011-114649

(51) Int. Cl. H02J 7/00

(52) U.S. Cl. 320/117

(57) ABSTRACT

There is provided a battery system having a plurality of storage batteries capable of charging and discharging, and at least two or more of the storage batteries are connected in series. The battery system includes a connecting terminal capable of connecting a storage battery in parallel with any one of the other storage batteries. The battery system is capable of replacing the storage battery without restricting the configuration to be serial connection or parallel connection, while avoiding decline of the output power.

### CROSS REFERENCE TO RELATED APPLICATIONS

The present application claims benefit of the filing date of Japanese Patent Application No. 2011-114649 filed on May 23, 2011, which is incorporated herein by reference.

### BACKGROUND OF THE INVENTION

1. Field of the Invention

The present invention relates to a battery system.

2. Description of the Related Art

A battery system configured by connecting storage batteries like a lithium-ion battery, a lead storage battery, a nickel hydride battery and the like is used in wide range of applications such as a smart grid, a backup power supply, and a power supply of transportations including railroad, automobile and ship etc. In such battery systems, it is important to appropriately manage status (degree of time degradation, accumulated operating time etc.) per each of a plurality of the storage batteries to ensure the overall performance of the battery system. Such status management is especially important when a lithium-ion battery is used as a storage battery.

A storage battery deteriorates under normal conditions as it is used continuously (i.e. as discharge and charge). In addition, the deterioration of a storage battery is caused by age as well. Further, when connecting and using a plurality of storage batteries, there may be a difference in degree of deterioration between the batteries. If such a difference is small, it may not affect the overall performance of the battery system. If the difference is large, however, the overall performance of the battery system may be lowered. For example, the output power may be lowered. In such a case, it is preferable to equalize (or keep within a specified range of difference) the degree of deterioration between the storage batteries by, for example, replacing the storage battery of which charging capacity has been significantly decreased.

When replacing a deteriorated storage battery, it is preferable to make the replacing unit be small in view of economic efficiency and convenience. In particular, when the storage batteries are connected in parallel, the smaller the replacing unit becomes, the smaller the cross current between the storage batteries connected in parallel becomes. Further, when replacing a storage battery, it is preferable to avoid suspending the discharge of the battery system or lowering the output level of the battery system whenever possible.

With regard to such techniques, for example, Japanese Unexamined Patent Application Publication JP2005-158565A describes an assembled battery including: a plurality of battery modules connected in parallel, the battery module including one or more battery packs connected in series, the battery pack including a plurality of secondary batteries, wherein the assembled battery is provided with a connector configured to replace one or more of the battery modules that are deteriorated without suspending the discharge and charge of the assembled battery.

However, the technique described in JP2005-158565A has the following problem.

That is, the battery pack described in JP2005-158565A is not flexible in use because the battery pack has a special shape. This may cause high production cost of the assembled battery and high cost of the battery pack.

Further, in the technique of JP2005-158565A, the assembled battery is replaced in the following way. First, a defective battery module is removed. Then a new battery module is connected to the connector and the connector socket where the defective battery module was previously connected. Therefore, in a case when the battery modules are connected in series, removing the defective battery module causes disconnection of the circuit. That means the power fall of the battery. Since disconnection of the circuit means stopping of discharge and charge, the technique of JP2005-158565A has restriction, or difficulty in replacing the battery.

For providing an assembled battery without having such restriction, it is important to configure a connection circuit between the battery modules such that the circuit is not disconnected when replacing a battery. Therefore, configuration of the connection circuit between the storage batteries may have limitations to avoid suspending discharge and charge when replacing the battery.

In light of the above, the purpose of the present invention is to provide a battery system capable of replacing the storage battery without limiting the configuration to be serial connection or parallel connection, while avoiding decline of the output.

### SUMMARY OF THE INVENTION

In view of the above-stated problems, the inventors have come up the idea of disposing a connecting terminal, which is capable of connecting a storage battery, in parallel with the storage battery to be replaced resolves the problem above. Herewith the present invention has been made.

According to the present invention, it is possible to provide a battery system capable of replacing storage batteries regardless of the configuration of the system whether it is serial connection or parallel connection while avoiding decline of the output.

### BRIEF DESCRIPTION OF THE DRAWINGS

FIG. 1 is a schematic diagram illustrating a configuration of a battery system according to a first embodiment;

FIG. 2 is a schematic diagram illustrating a configuration of a battery system according to a second embodiment;

FIG. 3 is a schematic diagram illustrating a configuration of a battery system according to a third embodiment;

FIG. 4 is a flow chart of replacing the battery in a battery system according to the first embodiment;

FIG. 5 is a schematic diagram illustrating a configuration of a battery system according to a fourth embodiment;

FIG. 6 is a schematic diagram illustrating an overall configuration of an electrical storage system to which a battery system according to the present embodiment is to be applied; and

FIG. 7 is a schematic diagram illustrating a rack capable of storing a storage battery in a battery system according to the embodiment.

### DETAILED DESCRIPTION OF THE PREFERRED EMBODIMENT

Hereinafter, a mode for implementing the present invention (referred to as an “embodiment”) will be explained in detail with reference to the drawings. However, the present invention is not limited to the following embodiments, and may be embodied in various forms without departing from the scope of the invention.

### 1. First Embodiment

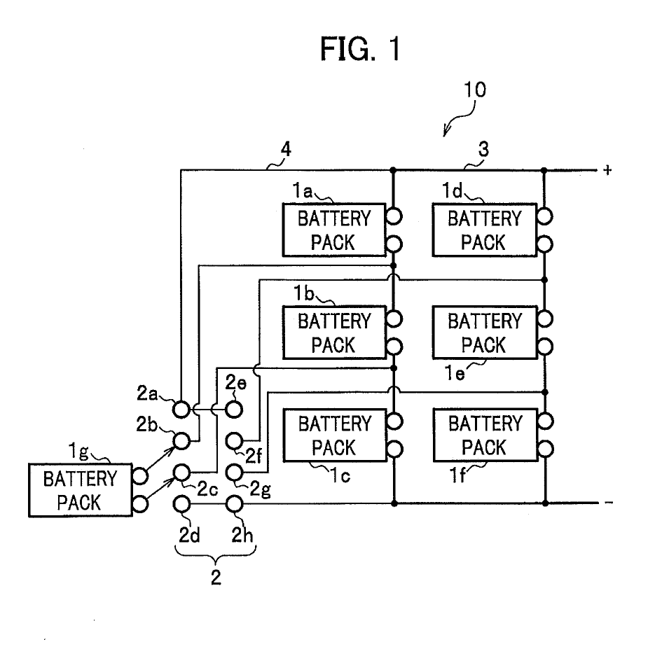

First, a battery system 10 according to the first embodiment will be explained with reference to FIG. 1. In the battery system 10 shown in FIG. 1, there are provided a rechargeable storage battery (a lithium-ion battery in this embodiment) and a plurality of battery packs 1 having a protection circuit and the like. The battery pack 1 serves as a storage battery, and is handled as a minimum unit of replacement when the storage battery is deteriorated.

In the example shown in FIG. 1, six battery packs are connected via a first wiring path 3. More specifically, three battery packs 1a, 1b and 1c are connected in series, and in addition other three battery packs 1d, 1e and 1f are also connected in series. Further, the three battery packs 1a, 1b and 1c and the other three battery packs 1d, 1e and 1f are connected in parallel. Meanwhile, the first wiring path 3 shown with a thick line in FIG. 1 represents a wiring (circuit) connecting the batteries and a later-mentioned power generator or an electrical load or the like.

In other words, a battery module configured by connecting the battery packs 1a, 1b and 1c in series and another battery module configured by connecting the battery packs 1d, 1e and 1f in series are connected in parallel. In addition, the numbers of the batteries in each of the battery modules are the same.

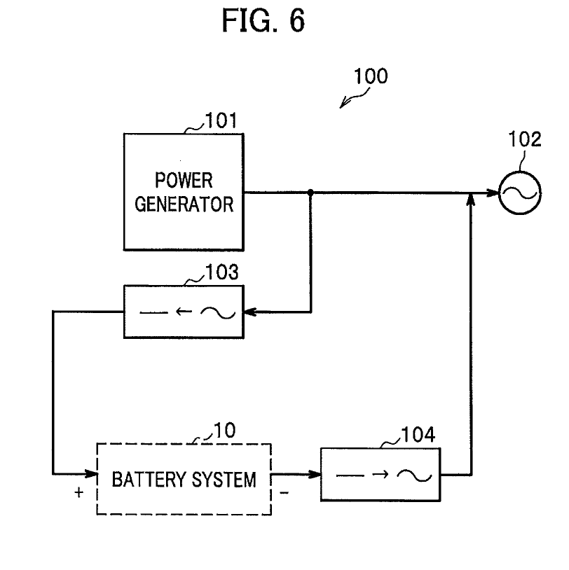

Note that, although not shown, both ends of the first wiring path 3 on the right hand side of FIG. 1 (+ and −) are connected to a power generator such as a solar battery and an electrical load respectively (the details will be discussed later with reference to FIG. 6).

Further, the battery system 10 is provided with a replacement terminal 2 to which a battery pack 1g is connected in parallel with one of the battery packs 1a to 1f. Here, the battery pack 1g is a new battery pack 1 to be replaced with the deteriorated battery pack and connected to the battery system 10 when one of the battery packs 1a to 1f is deteriorated.

More specifically, the battery system 10 is provided with replacement terminals 2a and 2b to which the battery pack 1g is connected in parallel with the battery pack 1a. Similarly provided are replacement terminals 2b and 2c with the battery pack 1b, a replacement terminals 2c and 2d with the battery pack 1c, a replacement terminals 2e and 2f with the battery pack 1d, replacement terminals 2f and 2g with the battery pack 1e, and a replacement terminals 2g and 2h with the battery pack 1f. Further, these replacement terminals 2 are connected to each of the battery packs 1 via the second wiring path 4 and the first wiring path 3.

Here, the second wiring path 4 shown with a thin line is a wiring (circuit) that connects the replacement terminals 2 and the battery pack 1 on the first wiring path 3. In other words, a deteriorated battery pack to be replaced and a new battery pack are connected via the second wiring path 4 and the first wiring path 3.

Next, operation of replacing a battery pack in the battery system 10 thus configured will be explained. More specifically, will be explained a case where the battery pack 1b is deteriorated during discharge of the battery system 10 and the battery pack 1b is to be replaced with a new battery pack 1g. Here, the battery pack 1 is provided with measurement units (not shown) for measuring a voltage applied to a storage battery in the battery pack 1, a current flowing in the battery pack, SOC(State of Charge) and the like. In addition, the battery system 10 is provided with a calculation unit (not shown) which determines the degree of deterioration on the basis of the measurement value obtained by each of the measurement unit.

In a case when the calculation unit has determined that the battery pack 1b is deteriorated significantly, the calculation unit displays on a display means (LCD, lamp or the like which is not shown) a message prompting replacement of the battery pack 1b. A user looking at the message connects a new battery pack 1g to the replacement terminals 2b and 2c which is connected in parallel with the battery pack 1b. Here, the battery pack 1g is charged in advance. At the moment when the battery pack 1g is connected, both the battery pack 1b and the battery pack 1g are supplied with current (turn-on state).

The battery pack 1g is less deteriorated than the battery pack 1b. Therefore, removing the battery pack 1b when both the battery pack 1b and battery pack 1g are in a turn-on state may not cause reduction of output voltage. Accordingly, by removing the battery pack 1b after connecting the battery pack 1g, it is possible to switch to the new battery pack 1g.

Further, the battery pack 1b and the battery pack 1g are connected in parallel. Therefore, by removing the battery pack 1b after connecting the battery pack 1g, it is also possible to maintain the turn-on-state of the battery packs 1a and 1c which are connected to the battery pack 1b in series. Thus, it is possible to replace the deteriorated battery pack 1b with the new battery pack 1g while keeping the discharge and charge state (i.e. while in use) of the battery packs 1a and 1c.

Next, will be explained a case where the battery pack 1b has been removed after the battery pack 1g is connected to the replacement terminal 2, and further the battery pack 1d is deteriorated and has to be replaced with a new battery pack (not shown).

At this moment, the replacement terminals 2 is connected with the battery pack 1g, while the terminals where the battery pack 1b was connected is open. In this state, first a new battery pack is to be connected to the terminals where the battery pack 1b was connected. When the new battery pack has been connected, both the battery pack 1g and the new battery pack are in a turn-on state.

Then, the battery pack 1g is re-connected so as to be in parallel with the battery pack 1d which has been determined as deteriorated. In other words, the battery pack 1g which has been connected to the replacement terminals 2b and 2c will be re-connected to the replacement terminals 2e and 2f. Note that, when the battery pack 1g is removed from the replacement terminals 2b and 2c, it means that the battery pack 1g is removed for a moment from the group where the battery packs 1a, 1b and 1c are connected in series.

Then, after the re-connection, both the deteriorated battery pack 1d and the battery pack 1g are in a turn-on state. Thus, similarly to the aforementioned case where replacing the battery pack 1b, it is possible to remove the deteriorated battery pack 1d without causing the reduction of the output voltage, while keeping the turn-on state of the battery packs 1e and 1f.

In this example, six battery packs 1 are connected during the normal operation of the battery system 10. Accordingly, in the normal operation, one terminal for connecting the battery pack 1 is open. Therefore, in a case when the battery pack 1g connected to the replacement terminals 2 has been deteriorated, all it needs to do is connecting a new battery pack to the open terminal on the first wiring path 3 first, then removing the battery pack 1g. Thus, similarly to the aforementioned case where replacing the battery pack 1b, it is possible to remove the battery pack 1g without causing the reduction of output voltage, while keeping the turn-on state of the battery packs 1a to 1f.

As stated above, in this embodiment, it is important to connect a new battery pack first in parallel with the battery pack 1 to be replaced, and then remove the battery pack 1. Thus, by removing a battery pack 1 according to the procedure above, it is possible to replace a deteriorated battery with a new battery without causing the reduction of output voltage.

### 2. Second Embodiment

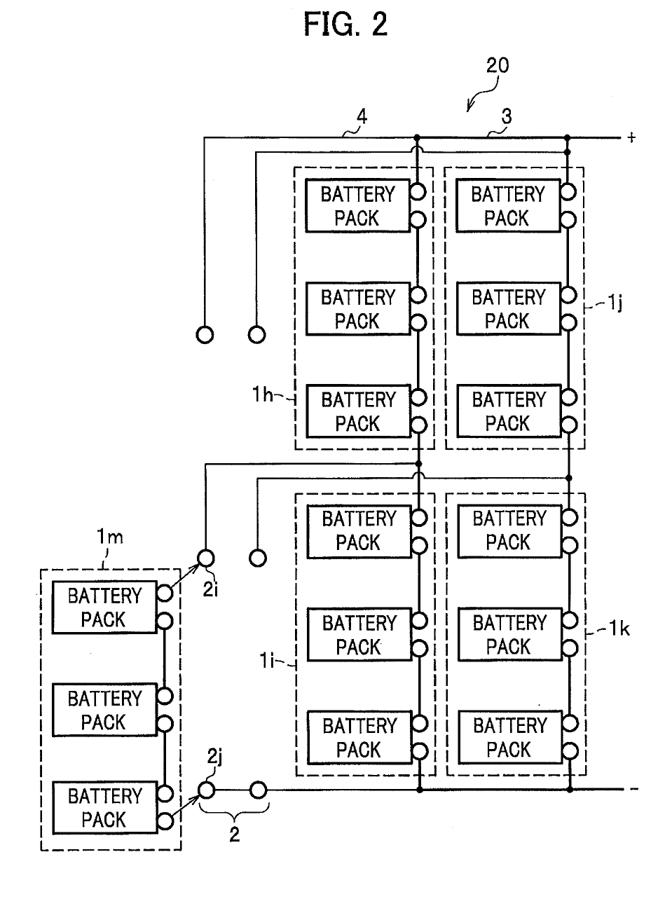

Next, a battery system 20 according to the second embodiment will be explained with reference to FIG. 2. Since the configuration of the battery system 20 is basically the same as that of the aforementioned battery system 10, different points from the battery system 10 will be mainly explained. In addition, in FIG. 2, similar symbols are used to denote similar components, and redundant explanations are omitted.

The battery system 20 shown in FIG. 2 includes a plurality of battery pack groups (storage battery groups) each including a plurality of battery packs (storage cell) as a replaceable minimum unit. More specifically, the battery system 20 shown in FIG. 2 includes four battery pack groups 1h, 1i, 1j and 1k each configured by connecting a plurality of battery packs in series. The battery groups 1h and 1i are connected in series, and also the battery packs 1j and 1k are connected in series. Further, the one battery groups 1h and 1i and the other battery groups 1j and 1k are connected in parallel.

The example of FIG. 2 shows an aspect in which the battery pack group 1i is removed and then a new battery pack group 1m is connected to the replacement terminals 2i and 2j. With regard to the battery system 20, it is also possible to replace the battery pack group 1i in the same way as the case of the battery system 10. In particular, in a case when high output voltage is required, battery pack groups having high output voltage is used. Therefore, the battery group 20 is appropriate for such applications. In other words, the battery system according to the present invention is applicable to applications which require high output voltage.

### 3. Third Embodiment

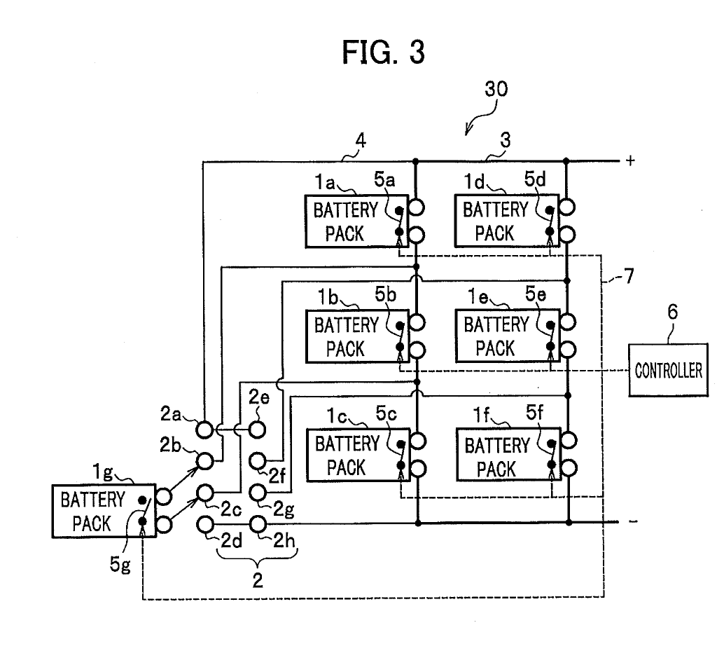

Next, a battery system 30 according to the third embodiment will be explained with reference to FIG. 3. Since the configuration of the battery system 30 is basically the same as that of the aforementioned battery system 10, different points from the battery system 10 will be mainly explained. In addition, in FIG. 3, similar symbols are used to denote similar components, and redundant explanations are omitted.

The battery system 30 further includes, in addition to the configuration of the battery system 10, a switch 5 capable of turning on-off control and a controller 6 that controls the switch 5. The switch 5 is disposed in each of the battery packs 1. In other words, the switch 5 is disposed in a circuit that connects the storage batteries in the battery pack 1. The switch 5 is connected to the controller 6 via an electrical signal line 7 through which the controller 6 performs turning on-off control of the switch 5.

Switching of the switch 5 is performed when replacing the battery pack 1. More specifically, the battery pack 1 may be attached to or removed from the battery system 30 when the switch 5 is in an off-state. Then the switch 5 is turned on after the battery pack 1 is connected to the battery system 30.

The controller 6 is configured with some components such as a Central Processing Unit (CPU). The controller 6 performs turning on-off control of the switch 5 in accordance with a command from a user (e.g. by pressing a specified button).

Next, operation of replacing the battery pack 1 in the battery system 30 will be explained. Hereinafter, similarly to the aforementioned case of the battery system 10 explained referring to FIG. 1, another case will be explained where the battery pack 1b is deteriorated during discharging and is to be replaced with a new battery pack 1g. The battery pack 1g is provided with a switch 5 similarly to the battery pack 1b.

When the user have noticed similarly to the aforementioned case of the battery system 10 that the battery pack 1b is deteriorated and if the user wants to replace the battery pack 1b, the user connects the battery pack 1g which is turned off to the replacement terminals 2b and 2c first. After connecting the battery pack 1g, the switch 5g is turned on. After this operation, both the battery pack 1b and the battery pack 1g are in a turn-on state.

After that the switch 5b of the battery pack 1b is turned off. This makes the battery pack 1 become turn-off state. Then the battery pack 1b which is in an off-state is removed and the replacement of the deteriorated battery pack 1b is completed.

Further, similarly to the aforementioned case of the battery system 10 explained referring to FIG. 1, another case will be explained where the battery pack 1d is deteriorated in this state and is to be replaced.

At this moment, the battery pack 1b has been removed from the battery system 30, and therefore a pair of terminals where the battery pack 1b was connected is open. First, a new battery pack (not shown) is connected to the pair of terminals. Here, the new battery pack is provided with a switch same as that of the battery pack 1b, of which the state is off-state when the new battery is connected.

After connecting the new battery pack, the switch of the new battery pack is turned on. Thus, both the switches of the battery pack 1g and of the new battery pack are in a turn-on state. After that, the switch 5g of the battery pack 1g is turned off, and then the battery pack 1g is removed and reconnected to the replacement terminals 2e and 2f so as to be in parallel with the battery pack 1b. After reconnecting the battery pack 1g, the switch 5g is turned on. Further, the switch 5d of the battery pack 1d is turned off, and then the battery pack 1d may be removed from the battery system 30.

Further in this state, if the battery pack 1g connected to the replacement terminal 2 needs to be removed, all it needs to do is connecting a new battery pack which is turned off to the open terminal on the first wiring path 3. After that, the switch 5 of the new battery pack 1g is turned on, and then the battery pack 1g may be removed.

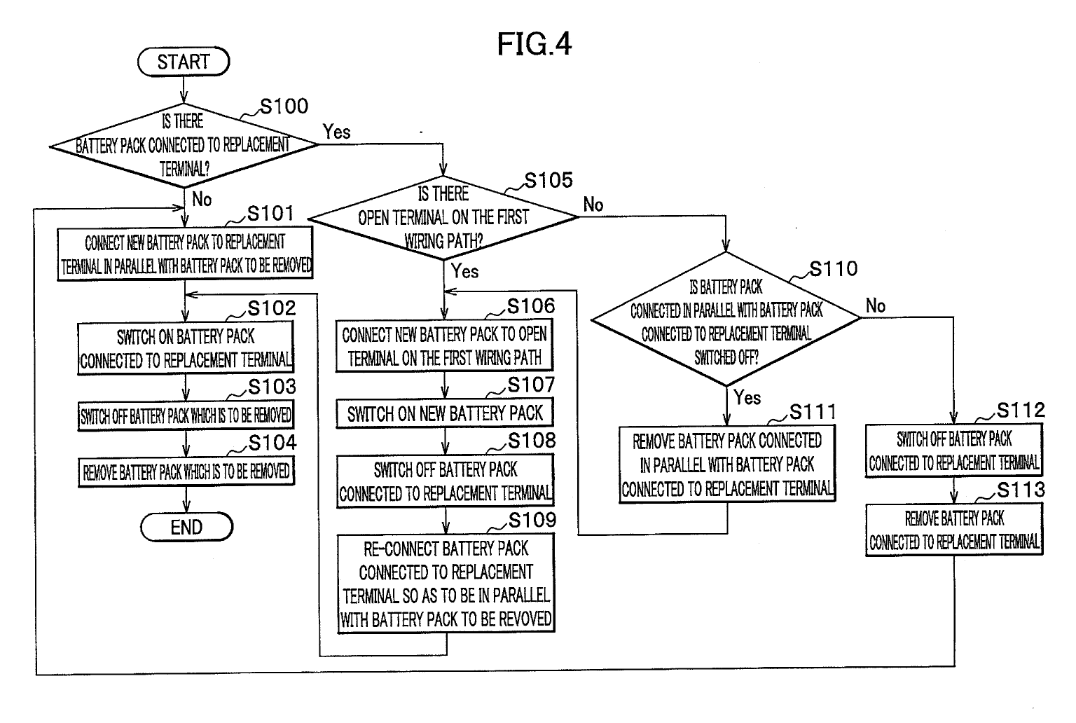

The processing flow of replacing a battery in the battery system 30 thus configured will be explained in detail referring to FIGS. 3 and 4. FIG. 4 shows a flowchart of replacing a battery in the battery system 30. Here, steps related to on-off switching are omitted so that the flow can be shared with the battery system 10 in FIG. 1 as well.

In addition, using “battery pack group” instead of “battery pack” and omitting steps related to on-off switching, the flow may be shared with the battery system 20 as well. Further, using “battery pack group” instead of “battery pack”, the flow may be shared with the after-mentioned battery system 40 as well.

In the flow shown in FIG. 4, operation of the switch 5 is performed by the controller 6 shown in FIG. 3 in response to the user's request.

First, the user checks whether or not the battery pack 1 is connected to the replacement terminals 2 (step S100). This step may be performed by checking with eyes by the user whether or not the battery pack 1 is connected. Alternatively the controller 6 may check whether or not the battery pack 1 is connected to the replacement terminals 2, and display the result on a display (not shown). Then the user may check the display with eyes. Accordingly, the “check” and “eye inspection” in the following explanation will be performed by at least any one of them.

If the replacement terminals 2 has no battery pack 1 connected thereto (No, at step S100), the user manually connects a new battery pack 1 (battery pack 1g in FIG. 3) to the replacement terminals 2 so that the new battery pack 1 becomes in parallel with the battery pack to be removed (battery pack 1b in FIG. 3) (step S101). Here, the switch 5 of the new battery pack 1 is turned off before being connected.

After the new battery pack 1 has been connected to the replacement terminal 2, the user manually switches on the switch 5 of the new battery pack 1 (step S102). Then the user switches off the switch 5 of the battery pack 1 to be removed (step S103). After these steps are completed, the battery pack 1 to be removed will be removed (step S104).

In contrast, at step S100, if the replacement terminals 2 has a battery pack 1 connected thereto (Yes, at step S100), the user checks with eyes whether or not there is any open terminals on the first wiring path 3 (step S105). In other words, the user checks whether or not one of the battery packs 1a to 1f has been removed.

If there is an open terminal on the first wiring path 3 (Yes, at step S105), the user manually connects a new battery pack 1 to the open terminals. Here, the switch 5 of the new battery pack 1 is turned off before being connected. After connecting the new battery pack 1 (step S106), the user switches on the switch 5 of the new battery pack 1 (step S107).

Next, the user switches on the switch 5 of the battery pack 1 connected to the replacement terminals 2 (step S108). After that, the user manually removes the battery pack 1, and then reconnects it to the replacement terminals 2 so that it becomes parallel with the battery pack 1 to be removed. (step S109). Then the aforementioned steps S102 to S104 are performed and removing the battery pack 1 to be removed is completed.

Similarly to the aforementioned battery system 10, six battery packs 1 are connected during the normal operation of the battery system 30. However, there may be seven battery packs 1 connected to the battery system 10 for some reason. That is, in some cases, the battery system 30 may be operated with seven battery packs 1. Next, such a case will be explained.

If it is determined that there is no open terminal on the first wiring path 3 (No, at step 105), i.e. all of the battery packs 1a to 1g are connected, the user checks whether or not the switch 5 of the battery pack 1b is turned off (step S110). More specifically, the user checks whether or not the switch 5 of the battery pack 1b connected in parallel with the battery pack 1 on the replacement terminals 2 is turned off.

If the switch 5 of the battery pack 1b is in an off-state (Yes, at step S110), the user removes the battery pack 1b (i.e. the battery pack 1 connected in parallel with the battery pack 1 on the replacement terminals 2) (step S111). After that, the aforementioned steps S106 to S109 are performed and replacing the battery is completed.

On the other hand, at step S110, if the switch 5 of the battery pack 1b is in an on-state (No, at step S110), the user switches off the switch 5 of the battery pack 1 (battery pack 1g) connected to the replacement terminals 2 (step S112). Then, the user manually removes the battery pack 1 connected to the replacement terminals 2 (step S113), and the steps S101 to S104 are performed and replacing the battery is completed.

### 4. Fourth Embodiment

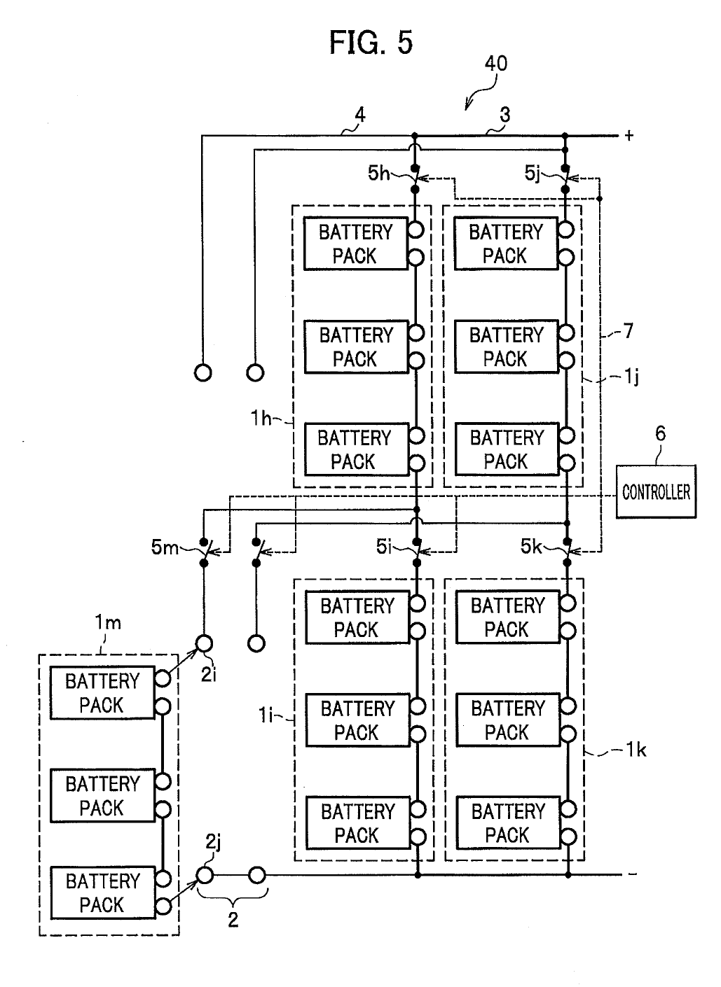

Next, a battery system 40 according to the third embodiment will be explained with reference to FIG. 5. Since the configuration of the battery system 40 is basically the same as that of the aforementioned battery systems 20 and 30, different points from the battery systems 20 and 30 will be mainly explained. In FIG. 5, symbols similar to FIGS. 2 and 3 are used to denote similar components, and redundant explanations are omitted.

The battery system 40 includes battery pack groups 1h, 1i, 1j and 1k each including a plurality of battery packs. The battery system 40 further provided with switches 5h, 5i, 5j and 5k in a circuit connecting the battery pack groups. The example of FIG. 5 shows an aspect in which the battery pack group 1i is removed and then a new battery pack group 1m is connected to the battery system 40.

In this case, similarly to the operation explained in the case of the battery system 30, the switch 5m may be controlled by the controller 6. After that, the battery pack group 1m may be manually connected. More specifically, the battery pack group 1m is connected while keeping the switch 5m in an off-state and then the switch 5m is turned on via the controller 6. By doing so, both the battery pack groups 1i and 1m become a turn-on state. Then the switch 5 is turned off and the battery pack group 1i can be removed from the battery system 40.

In addition, replacing battery pack groups 1i, 1j, 1k and 1m in this state can be performed in a similar way explained in the cases of battery systems 20 and 30.

### 5. Summary

The embodiment has been explained referring to four examples. As stated above, in the battery system according to the embodiment, for replacing a deteriorated battery pack or the like (i.e. battery pack or battery pack group), a new battery pack or the like is connected in parallel first. Then the deteriorated battery pack or the like is replaced. In the battery system according to the embodiment, it is possible to replace a deteriorated battery without causing a drop in output power regardless of the circuit configuration. The battery system according to the embodiment can be applied to either of a battery pack group having a single storage battery and a battery pack group having a plurality of storage batteries. Consequently, there is no limitation of applicable configuration of the storage battery.

When replacing a deteriorated battery in a conventional system, a new battery pack or the like which corresponds to a whole unit connected in series needs to be added first, and then a deteriorated battery pack or the like is removed. In such a case, it is necessary to prepare an additional whole unit connected in series. This causes a problem that the replacement process can be complicated. According to the battery system of the present embodiment, such a whole unit is not required. An advantageous effect is that, since a general battery pack can be simply added, the replacement process can be simplified.

Further, as explained referring to FIG. 3 etc., the switch 5 capable of controlling current in the battery pack 1 makes it possible to stop and start a battery pack or a battery pack group safely.

### 6. Application Field and Installation Mode

### (Application Field)

The battery system according to the present embodiment is applicable to, for example, a drive power supply for land-sea-and-air transportation, a smart grid, a backup power supply, etc.

Recently, a power generator using natural energy is becoming popular from the aspect of less affection to natural environment. However, the electrical generating capacity of such a generator using natural energy is dependent on electrical generating capacity although it has less affection to natural environment. That is to say, under some condition of nature, it may be difficult to achieve the electrical generating capacity necessary to the electrical load.

For example, in a case where using a solar photovoltaic device, it is possible to generate large amount of electrical power in summer when solar light intensity is high. On the other hand, an amount of electrical power decreases in winter when solar light intensity is low. Accordingly, there is a seasonal difference in the amount of electric power generation.

Therefore, the battery system according to the present embodiment can be utilized effectively combined with such a power generator of which an amount of electric power generation varies. More specifically, for example, it may be applied to an electrical storage system 100 having a configuration shown in FIG. 6.

The electrical storage system 100 includes a battery system 10, a power generator 101, an electrical grid 102, an AC/DC conversion device (converter) 103, and a DC/AC conversion device (inverter) 104. Although a battery system 10 is applied in FIG. 6, a battery system 20, a battery system 30, or a battery system 40 may be applied in a similar way.

The power generator 101 is a power generator that generates power using natural energy such as wind, waterpower, geothermal power, tidal power, photovoltaic power or the like. In addition, the battery system 10 is connected as shown by symbols (+) and (−) in FIG. 6.

An electrical grid 102 is connected to electrical load (not shown). So, power from the power generator 101 or the battery system 10 is provided to the electrical load via the electrical grid 102.

The electrical power generated by the power generator 101 and the electrical power demanded by the electrical load are alternate current. On the other hand, the electrical power the battery system 10 can store is direct current. Accordingly, between the power generator 101 and the battery system 10 there is provided a DC/AC converter 103 which converts direct-current to alternating-current. In addition, between the battery system 10 and the electrical load 102 there is provided a AC/DC converter 104 which converts alternating-current to direct-current.

In the electrical storage system 100, in a case when the electrical power generated by the power generator 101 is larger than the electrical power demanded by the electrical load, the surplus power is stored in the battery system 10. In contrast, in a case when the electrical power demanded by the electrical load is larger than the electrical power generated by the power generator 101, the shortfall is covered by the battery system 10 and provided to the electrical load. Thus it is possible to provide electrical power in a stable manner regardless of the change of natural energy, i.e. environmental changes. Here, the processes are controlled by a control circuit or a calculation unit which are not shown.

(Installation mode)

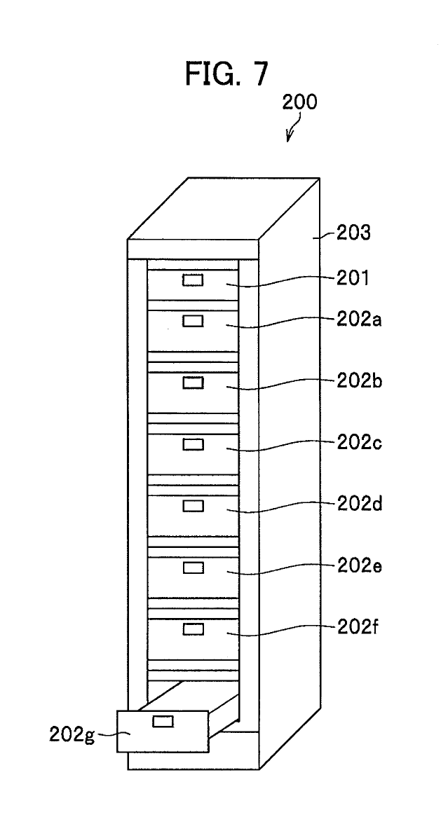

A specific installation mode of the battery system 10 is shown in FIG. 7 for example. A battery apparatus 200 includes: a circuit storage 201 that stores a calculation unit, a cable, and a control circuit; a battery pack storage 202 that stores a battery pack 1; and a housing 203 that stores a circuit storage 201 and a battery pack storage 202.

In the example shown in FIG. 7, since the battery system 10 is adopted, the battery pack storages that store the battery pack 1a to 1g are referred to as the battery pack storages 202a to 202g respectively. Further, the installation mode shown in FIG. 7 can be similarly applied to the battery system 20, the battery system 30 and the battery system 40.

Although not shown in the battery apparatus 200 in FIG. 7, the battery packs 1 stored in each of the battery pack storages 202 are wired as shown in FIG. 1. In this case, replacement terminals 2 in the battery system 10 are put together as a set of replacement terminals controlled by a control circuit (not shown). More specifically, thus integrated set of replacement terminals are disposed at the lowermost part of the housing 203.

The battery packs 1 stored in the battery pack storages 202 are connected to the circuit storage 201 and other battery packs 1 via a connector. Namely, the battery pack storages 202 are detachable to and from the battery apparatus 200 so that replacing the battery pack storages 202 (i.e. battery pack 1) is easy. More specifically, the battery pack storage 202g is inserted to the lowermost part and the connection is switched by the control circuit so that the newly inserted battery pack storage 202 can be in parallel with any of the battery packs 1.

### 7. Modified Example

The battery systems according to the present embodiments have been explained above. However, the embodiments of the present invention are not limited to those explanations, and various modifications can be made without departing from the spirit and scope of the invention.

For example, a lithium-ion battery is used as a storage battery in the aforementioned battery pack 1, but a lead storage battery or the like may be used alternatively. In addition, the protection circuit may be omitted or other circuits may be provided as needed. Furthermore, the number of storage batteries included in the battery pack 1 is not limited to one, and a plurality of storage batteries may be included in the battery pack 1.

In addition, three battery packs are used to constitute a battery pack group in the aforementioned example, but the number of battery packs is not limited thereto. For example, two or four or more battery packs may be included.

In the aforementioned example, replacement terminals 2 are disposed corresponding to each of the battery packs or each of the battery pack groups. However, the replacement terminals 2 may be put together as a set of replacement terminals controlled by a control circuit (see FIG. 7). This configuration minimizes the installation space of a newly added battery pack and contributes the downsizing of the apparatus. In addition, it is possible to reduce the replacement terminals.

With respect to a switch provided to the battery system, the battery system 30 has the switch in the battery pack 1, and the battery system 40 has the switch outside the battery pack groups. However, the locations of the switches are not limited thereto as long as the switches are disposed in a circuit connecting the storage batteries. For example, the battery system 30 may have the switch outside the battery pack 1, and the battery system 40 may have the switch in the battery pack groups.

Further, with respect to the replacement terminals 2 shown in FIG. 1, the replacement terminal 2a and the replacement terminal 2e may be integrated since they are connected to each other. More specifically, the replacement terminal 2a and the replacement terminal 2e may be integrated as a replacement terminal 2′. When replacing the battery pack 1a, a new battery pack 1g may be connected to the replacement terminals 2′ and 2b. Further, when replacing the battery pack 1d, a new battery pack 1g may be connected to the replacement terminals 2′ and 2f. The replacement terminal 2d and the replacement terminal 2h may be replaced in a similar manner. This configuration reduces the number of the replacement terminals 2. This configuration may be applied to FIGS. 2, 3 and 5 as well.

FIG. 4 is a flow chart based on the premise that replacing the battery in a battery system is performed by a user manually. Alternatively, the controller 6 may check the degree of deterioration of battery packs. The controller 6 may switch from a deteriorated battery pack to a new battery pack 1 connected in advance so that the new battery pack is connected to the first wiring path 3. In other words, the controller 6 may actively perform these steps.

What is claimed is:

1. A battery system, comprising;
a plurality of storage batteries capable of charging and discharging, at least two or more of the storage batteries being connected in series;
a connecting terminal capable of connecting one storage battery in parallel with any one of the other storage batteries.

2. The battery system according to claim 1, wherein the storage battery comprises a plurality of storage cells.

3. The battery system according to claim 1 further comprising: a plurality of battery modules, wherein each of the battery modules includes a plurality of the storage batteries connected in series, and includes the same number of storage batteries.

4. The battery system according to claim 1 further comprising a switch for on-off control of current flowing inside the storage batteries.

5. The battery system according to claim 4, wherein the switch is disposed in a circuit that connects the storage batteries to each other.

6. The battery system according to claim 1, wherein the storage battery comprises a lithium-ion battery.
